(19) United States
(12) Patent Application Publication
(10) Pub. No.: US 2015/0125074 A1
(43) Pub. Date: May 7, 2015

(54) APPARATUS AND METHOD FOR EXTRACTING SKIN AREA TO BLOCK HARMFUL CONTENT IMAGE

(71) Applicant: ELECTRONICS AND TELECOMMUNICATIONS RESEARCH INSTITUTE, Daejeon (KR)

(72) Inventors: Jung-Jae Yu, Daejeon (KR); Seung-Wan Han, Gwangju (KR); Moo-Seop Kim, Sejong (KR); Su-Gil Choi, Daejeon (KR); Chi-Yoon Jeong, Daejeon (KR)

(73) Assignee: ELECTRONICS AND TELECOMMUNICATIONS RESEARCH INSTITUTE, Daejeon (KR)

(21) Appl. No.: 14/178,916

(22) Filed: Feb. 12, 2014

(30) Foreign Application Priority Data
Nov. 5, 2013 (KR) 10-2013-0133547

(51) Int. Cl. G06T 11/60; G06T 7/40; G06K 9/00; G06K 9/46

(52) U.S. Cl. CPC G06T 11/60; G06K 9/4604; G06T 7/408; G06K 9/00536; G06K 9/4647; G06K 2009/4666
USPC 382/164; 382/195

(57) ABSTRACT

Disclosed are an apparatus and method for extracting a skin area to block a harmful image. The apparatus includes an image extraction unit, a skin sample area extraction unit, a background sample area extraction unit, a probability density function computation unit, and a skin area extraction unit. The image extraction unit extracts an image from image media. The skin sample area extraction unit extracts a skin sample area of the image based on prior information. The background sample area extraction unit extracts a background sample area of the image based on the prior information. The probability density function computation unit calculates the probability density functions of the skin sample area and the background sample area. The skin area extraction unit extracts a skin area from the image based on the probability density function of the skin sample area and the probability density function of the background sample area.

### CROSS REFERENCE TO RELATED APPLICATION

This application claims the benefit of Korean Patent Application No. 10-2013-0133547, filed on Nov. 5, 2013, which is hereby incorporated by reference in its entirety into this application.

### BACKGROUND OF THE INVENTION

1. Technical Field

The present invention relates generally to an apparatus and method for extracting a skin area to block a harmful content image, and, more particularly, to an apparatus and method for extracting a skin area to block a harmful content image, which automatically extract a skin color area from a current frame image, input during the provision of streaming service or the playing of a moving image, using prior knowledge of the characteristics of harmful content images and adaptively generated skin and background color distribution information.

2. Description of the Related Art

With the development of communication network technology and the popularization of personal computers (PCs) and mobile devices, it has become more common to download and view image content regardless of temporal and spatial limitations.

In contrast, with an increase in the convenience of the enjoyment of entertainment culture, the risk in which children and adolescents are exposed to harmful content, such as an obscene moving image, has also increased.

In response to this, a demand for technology for analyzing image content, automatically determining the harmfulness of the image content, and blocking harmful content is increasing.

Most technologies for determining and blocking harmful content determine the harmfulness of content by comparing a harmful word included in a file name or file summary information with previously registered information. However, the technology for determining and blocking harmful content using a file name and file summary information is problematic in that it is difficult to block harmful content when a distributor changes the file name and/or file summary information of the harmful content and then distributes the corresponding harmful content.

Accordingly, a demand for technology for extracting a skin area from an input image and determining the harmfulness of the content is increasing. In this case, the technology for determining the harmfulness of content through the extraction of a skin area has the following structure.

A skin area is extracted from a first input image, and feature vectors indicative of the location of the center of mass and a distribution pattern for each area are calculated from a set of pixels included in the extracted skin area. A recognizer, such as a multi-layer perceptron (MLP) or a support vector machine (SVM), using such calculated feature vectors as input is taught such that the recognizer can determine whether an input image is harmful (i.e., whether an input image includes an obscene image).

In this case, the process of automatically extracting the skin area of a human from an input image is a preprocessing process that is commonly used to determine harmfulness in many existing researches related to the blocking of harmful content. In connection with this, many existing researches have been conducted.

M. J. Jones (CVPR, 1999) proposed a method of determining whether a color in question corresponds to a skin color using a maximum-likelihood estimation (MLE) method based on an enormous amount of skin and non-skin learning data. As illustrated in FIG. 1, the MLE method is used to detect a skin area through learning step 10 and test step 20.

At learning step 10, the estimation 12 of skin color and non-skin color distributions are estimated is performed based on learning data images 11 collected from the Web, and skin color and non-skin color model prior knowledge 13 is stored.

At test step 20, the extraction 21 of a skin area from a test image is performed based on the learning data of skin and non-skin groups (i.e., the skin color and non-skin color model prior knowledge 13). That is, the color distribution histogram (probability density function) of each group is obtained from the learning data of skin and non-skin groups (i.e., the skin color and non-skin color model prior knowledge 13), and the histogram information is considered to be the likelihood probability of each group, thereby determining whether the color of each pixel of an input image corresponds to a skin color using an MLE method at the test step. The MLE method performs a postprocessing process 22 that excludes an area belonging to the extracted skin areas and having a high edge component density from skin areas on the assumption that the area has a strong possibility of being a non-skin area. This method is problematic in that a wide loss section is generated in MLE because the various color distributions of all non-skin areas other than a skin area are modeled by a single class in order to make comparison with a skin area class. As a result, a disadvantage arises in that low performance is achieved for test images related to various races, such as Asians, Caucasians and the like, and various lighting environment-related changes.

In order to overcome the above problem, research has been carried out into an object detection-based skin area extraction method that estimates an adaptive skin color model for an input image based on information about a portion around a specific bodily portion (i.e., an object) and then extracts a skin area. That is, attempts has been made to, in order to perform skin area extraction robust to the variety of skin colors and lighting environment-related changes, automatically detect a specific bodily portion (i.e., an object), such as a face and eyes, estimate skin color distributions within a current input image from the detected bodily portion information and then extract a skin area using MLE and MLP based on the estimated skin color distributions. As illustrated in FIG. 2, in the object detection-based skin area extraction method, skin area color distribution modeling 40 is performed on a test image based on information about an area around a specific bodily portion detected through specific portion object detection 30. Thereafter, skin area extraction 50 from the test image is performed based on the results of the skin area color distribution modeling 40.

J. Lee (INCNN, 2006) automatically detected a face area from an input image using Viola Jones' Cascade Adaboost, estimated a skin color distribution model within the current input image from the detected face area using principal component analysis (PCA), and then extracted a skin area using the estimated skin color distribution model.

Jang Seok-Woo (JIST, 2011) proposed a method that detected an eye area from an input image using R. Hsu's eye detection method (PAMI, 2002), estimated elliptical skin color distribution model variables using skin color pixels around the detected eye area and then extracted a skin area using the elliptical skin color distribution model variables.

However, since these methods require the preceding separate object detection step of automatically detecting a specific bodily portion, the skin area extraction methods performed as a type of preprocessing process are not suitable in terms of operating speed and system complexity.

### SUMMARY OF THE INVENTION

Accordingly, the present invention has been made keeping in mind the above problems occurring in the conventional art, and an object of the present invention is to provide an apparatus and method for extracting a skin area to block a harmful content image, which are configured to calculate the probability density functions of a skin area and a background area from an image and extract a skin area using an MLE method based on the calculated probability density functions, thereby minimizing false positive rate during a process of extracting a skin area from an image.

In accordance with an aspect of the present invention, there is provided an apparatus for extracting a skin area to block a harmful content image, including an image extraction unit configured to extract an image from image media; a skin sample area extraction unit configured to extract a skin sample area of the image based on previously stored prior information; a background sample area extraction unit configured to extract a background sample area of the image based on the prior information; a probability density function computation unit configured to calculate the probability density function of the skin sample area and the probability density function of the background sample area; and a skin area extraction unit configured to extract a skin area from the image based on the probability density functions of the skin sample area and the background sample area.

The skin sample area extraction unit may include an alpha image generation module configured to generate a gray image-type alpha image for the image based on the prior information; an alpha image postprocessing module configured to, in the alpha image, correct pixels included in a false negative area and pixels included in a skin area; and a skin sample area alpha map generation module configured to generate a binary skin sample area alpha map based on the alpha image corrected by the alpha image postprocessing module.

The alpha image generation module may generate the alpha image by calculating alpha values based on a color vector value at each coordinates, and a skin area probability density function value and a background area probability density function value for each color or based on a color vector value at each coordinates, a standard deviation of pixels of each color and an average value of pixels of each color and then assigning the alpha values to respective pixels included in the image.

On an assumption that an area which is isolated within an area of the alpha image classified as a skin area, an area whose three sides are adjacent to a skin area and whose brightness values are classified as a skin area, and an area which has similar brightness values and which is considered to be a background area are target pixels, the alpha image postprocessing module may increase alpha values of pixels included in the corresponding areas.

The alpha image postprocessing module may increase alpha values by performing a conditional morphology closing operation and a conditional morphology dilation operation on pixels of the alpha image which are included in a skin area and in which a difference between their pixel value and a maximum value or minimum value within a window falls within a specific range.

The background sample area extraction unit may include an edge-based background sample area extraction module configured to generate an edge-based background alpha map based on a background area extracted from the image; a peripheral background sample area extraction module configured to generate a peripheral background area alpha map based on the image; and a summation module configured to generate a background sample area alpha map by summing the edge-based background alpha map and the peripheral background area alpha map.

The edge-based background sample area extraction module may include an edge operation module configured to calculate edge components at respective pixels included in the image using an edge operator, and to generate a binary edge map by mapping an edge value to each of the pixels based on the edge components and a threshold value; and an edge density-based background block determination module configured to segment the image into a plurality of blocks, to sum the edge values of pixels included in each of the blocks, and to generate an edge-based background alpha map by assigning alpha values to the respective pixels included in each of the blocks based on the sum of the edge values of each of the blocks and a set value.

The peripheral background sample area extraction module may include a peripheral area block-based color distribution operation module configured to segment a left, right and upper end edge area of the image into a plurality of peripheral blocks, and to calculate a color distribution histogram of each of the peripheral blocks; and a peripheral background block determination module configured to calculate color distribution errors with respect to other peripheral blocks and a reference function for each of the plurality of peripheral blocks, to detect a number of blocks having similar color distributions based on the color distribution errors, and to generate a peripheral background area alpha map by assigning alpha values to pixels included in the peripheral blocks based on the number of blocks having similar color distributions, the reference function and a set value.

The probability density function computation unit may include a foreground skin sample area alpha map generation module configured to generate a foreground skin sample area alpha map in which an overlap area between the skin sample area alpha map generated by the skin sample area extraction unit and the background sample area alpha map generated by the background sample area extraction unit has been excluded from the background sample area alpha map generated by the background sample area extraction unit; and a histogram operation module configured to calculate a histogram of the generated foreground skin sample area alpha map and a histogram of the background sample area alpha map.

The skin area extraction unit may include an maximum-likelihood estimation (MLE)-based area determination module configured to generate an MLE skin alpha map of the image based on the histogram of the foreground skin sample area alpha map and the histogram of the background sample area alpha map calculated by the probability density function computation unit; and a postprocessing module configured to generate a final skin area alpha map by eliminating noise components from an alpha map generated by multiplying the MLE skin alpha map by the skin sample area alpha map generated by the skin sample area extraction unit.

In accordance with another aspect of the present invention, there is provided a method of extracting a skin area to block a harmful content image, including extracting, by an image extraction unit, an image from image media; extracting, by a skin sample area extraction unit, a skin sample area of the image based on the image and previously stored prior information; extracting, by a background sample area extraction unit, a background sample area of the image based on the image and the prior information; calculating, by a probability density function computation unit, the probability density function of the skin sample area and the probability density function of the background sample area; and extracting, by a skin area extraction unit, a skin area from the image based on the probability density functions of the skin sample area and the background sample area.

Extracting the skin area may include generating, by the skin sample area extraction unit, a gray image-type alpha image for the image based on the prior information; correcting, by the skin sample area extraction unit, pixels included in a false negative area of the alpha image; correcting, by the skin sample area extraction unit, pixels included in a skin area of the alpha image; and generating, by the skin sample area extraction unit, a binary skin sample area alpha map based on the alpha image in which the pixels included in the false negative area and the skin area have been corrected.

Generating the alpha image may include, by the skin sample area extraction unit, generating the alpha image by calculating alpha values based on a color vector value at each coordinates, and a skin area probability density function value and a background area probability density function value for each color or based on a color vector value at each coordinates, a standard deviation of pixels of each color and an average value of pixels of each color and then assigning the alpha values to respective pixels included in the image.

Correcting the pixels in the false negative area may include, on an assumption that an area which is isolated within an area of the alpha image classified as a skin area, an area whose three sides are adjacent to a skin area and whose brightness values are classified as a skin area, and an area which has similar brightness values and which is considered to be a background area are target pixels, increasing, by the skin sample area extraction unit, alpha values of pixels included in the corresponding areas.

Correcting the pixels included in the skin area may include increasing, by the skin sample area extraction unit, alpha values by performing a conditional morphology closing operation and a conditional morphology dilation operation on pixels of the alpha image which are included in a skin area and in which a difference between their pixel value and a maximum value or minimum value within a window falls within a specific range.

Extracting the background sample area may include generating, by the background sample area extraction unit, an edge-based background alpha map based on a background area extracted from the image; generating, by the background sample area extraction unit, a peripheral background area alpha map based on the image; and generating, by the background sample area extraction unit, a background sample area alpha map by summing the edge-based background alpha map and the peripheral background area alpha map.

Generating the edge-based background alpha map may include calculating, by the background sample area extraction unit, edge components at respective pixels of the image using an edge operator; generating, by the background sample area extraction unit, a binary edge map by mapping an edge value to each of the pixels based on the edge components and a threshold value; segmenting, by the background sample area extraction unit, the image into a plurality of blocks, and summing, by the background sample area extraction unit, the edge values of pixels included in each of the blocks; determining, by the background sample area extraction unit, whether each of the blocks is a background area block or a skin area block by comparing the sum of the edge values and a set value; and generating, by the background sample area extraction unit, an edge-based background alpha map by assigning alpha values to the background area and skin area blocks.

Generating the peripheral background area alpha map may include segmenting, by the background sample area extraction unit, the image into a plurality of peripheral blocks; calculating, by the background sample area extraction unit, color distribution histograms of the peripheral blocks; calculating, by the background sample area extraction unit, color distribution errors with respect to other peripheral blocks for each of the plurality of peripheral blocks; calculating, by the background sample area extraction unit, reference functions of the plurality of peripheral blocks; extracting, by the background sample area extraction unit, peripheral blocks for which a number and reference function of peripheral blocks whose color distribution errors are equal to or smaller than a set value are equal to or larger than a set value, as peripheral blocks belonging to a background area; and generating, by the background sample area extraction unit, a peripheral background area alpha map by assigning alpha values to pixels of the peripheral blocks extracted as peripheral blocks belonging to a background area and other pixels.

Calculating the probability density functions may include generating, by the probability density function computation unit, a foreground skin sample area alpha map in which an overlap area between the skin sample area alpha map and the background sample area alpha map has been excluded from the background sample area alpha map; and calculating, by the probability density function computation unit, a histogram of the generated foreground skin sample area alpha map and a histogram of the background sample area alpha map.

Extracting the skin area from the image may include generating, by the skin area extraction unit, an MLE skin alpha map of the image based on the histogram of the foreground skin sample area alpha map and the histogram of the background sample area alpha map; and generating, by the skin area extraction unit, a final skin area alpha map by eliminating noise components from an alpha map that is generated by multiplying the MLE skin alpha map by the skin sample area alpha map.

### BRIEF DESCRIPTION OF THE DRAWINGS

The above and other objects, features and advantages of the present invention will be more clearly understood from the following detailed description taken in conjunction with the accompanying drawings, in which:

FIGS. 1 and 2 are diagrams illustrating a conventional skin area extraction method;

FIG. 3 is a block diagram illustrating an apparatus for extracting a skin area to block a harmful content image according to an embodiment of the present invention;

FIGS. 4 to 9 are diagrams illustrating the skin sample area extraction unit of FIG. 3;

FIGS. 10 to 14 are diagrams illustrating the background sample area extraction unit of FIG. 3;

FIGS. 15 to 17 are diagrams illustrating the probability density function computation unit of FIG. 3;

FIG. 18 is a diagram illustrating the skin area extraction unit of FIG. 3;

FIG. 19 is a flowchart illustrating a method of extracting a skin area to block a harmful content image according to an embodiment of the present invention;

FIG. 20 is a flowchart illustrating the skin sample area extraction step of FIG. 19;

FIGS. 21 to 23 are flowcharts illustrating the background sample area extraction step of FIG. 19;

FIG. 24 is a flowchart illustrating the probability density function operation step of FIG. 19; and

FIG. 25 is a flowchart illustrating the skin area extraction step of FIG. 19.

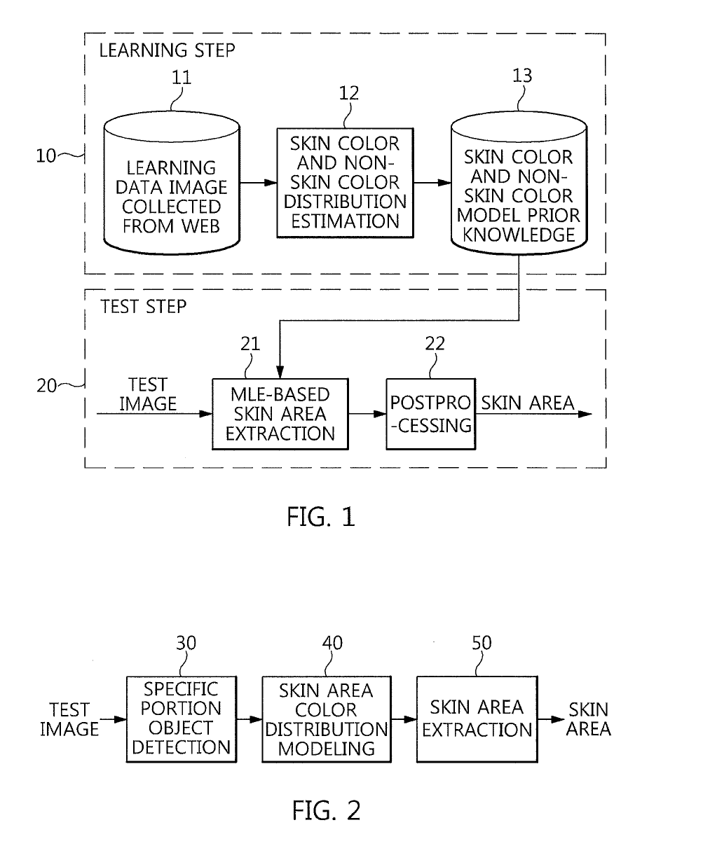

### DESCRIPTION OF THE PREFERRED EMBODIMENTS

In order to describe the present invention in detail so that those having ordinary knowledge in the technical field to which the present invention pertains can readily practice the technical spirit of the present invention, preferred embodiments of the present invention will be described below with reference to the accompanying drawings. It should be noted that the same reference numerals are used throughout the different drawings to designate the same or similar components. Furthermore, in the following description, when it is determined that detailed descriptions of well-known functions related to the present invention and configurations thereof would make the gist of the present invention obscure, they will be omitted.

First, terms that are used in the detailed description of an apparatus and method for extracting a skin area to block a harmful content image according to embodiments of the present invention will be described below.

The term “harmful content image” refers to an obscene moving image that shows the sexual organ or naked body of a male or a female, a sexual act, a pseudo-sexual act, or the like.

The term “background area” refers to all the area of an input image except for the skin areas of one or more humans.

The term “probability density function” refers to a probability density function that is used in probability theory. In the embodiments of the present invention, the term “probability density function” refers to histogram information that has been normalized such that the total sum becomes 1. In this case, the probability density function means maximum likelihood estimation (i.e., likelihood in an MLE determination process).

The term “alpha map” refers to a data map in which 0 or 1 has been assigned to each pixel location in order to distinguish layers within an input image. In this case, various types of alpha maps using various methods, such as an alpha map in which 0 or 255 has been assigned, may be employed, as needed.

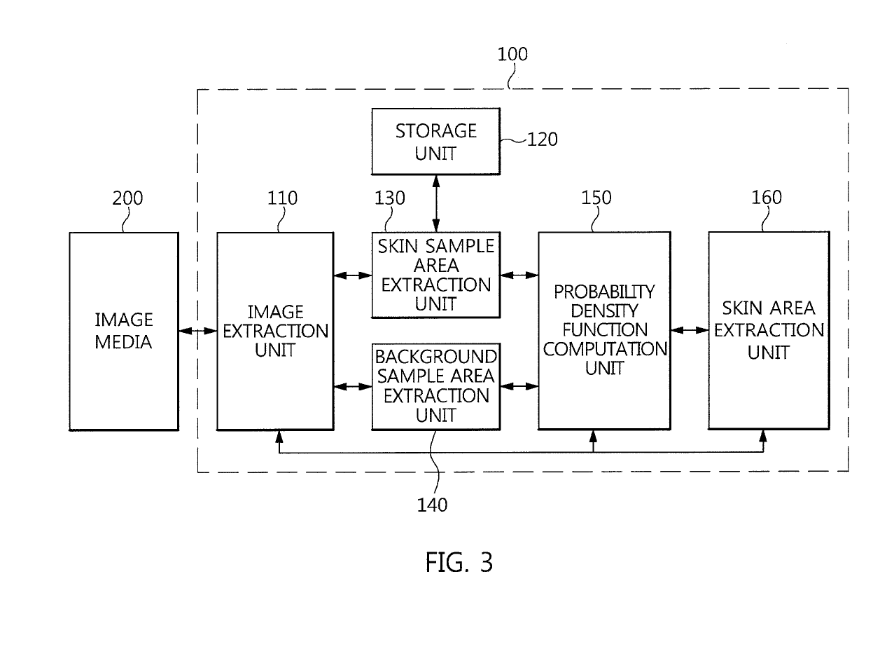

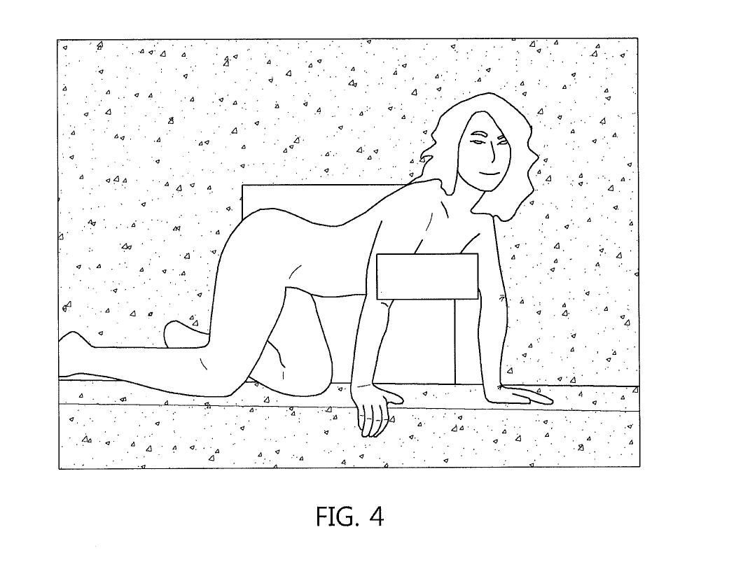

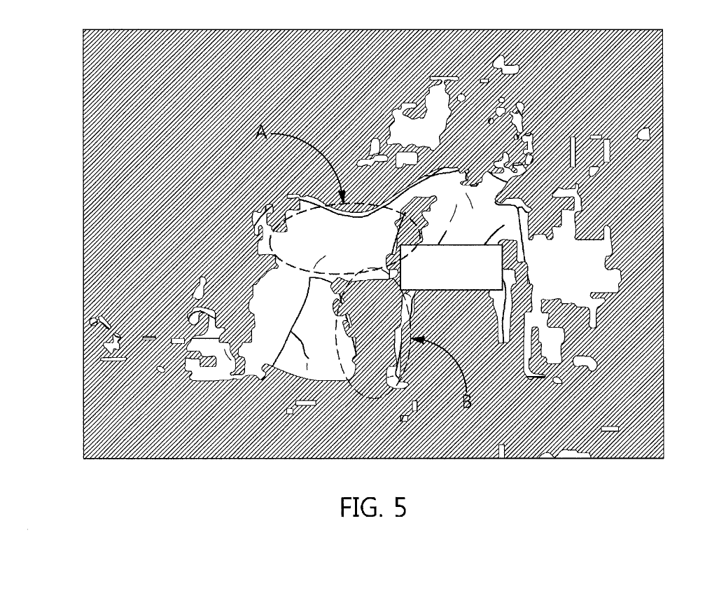

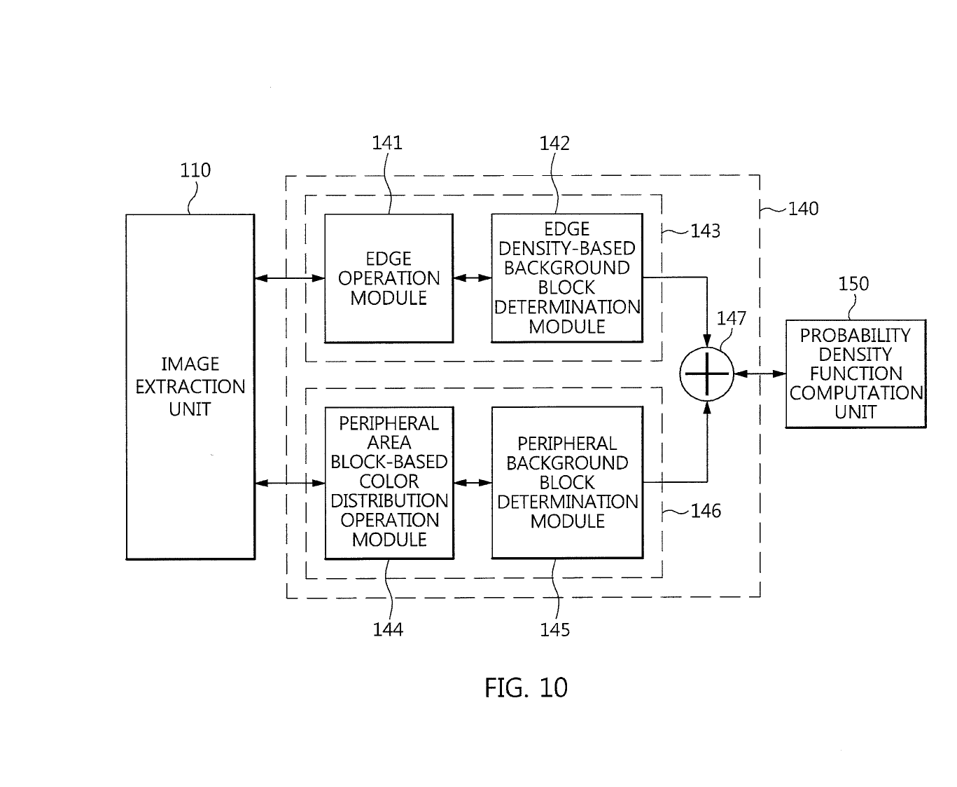

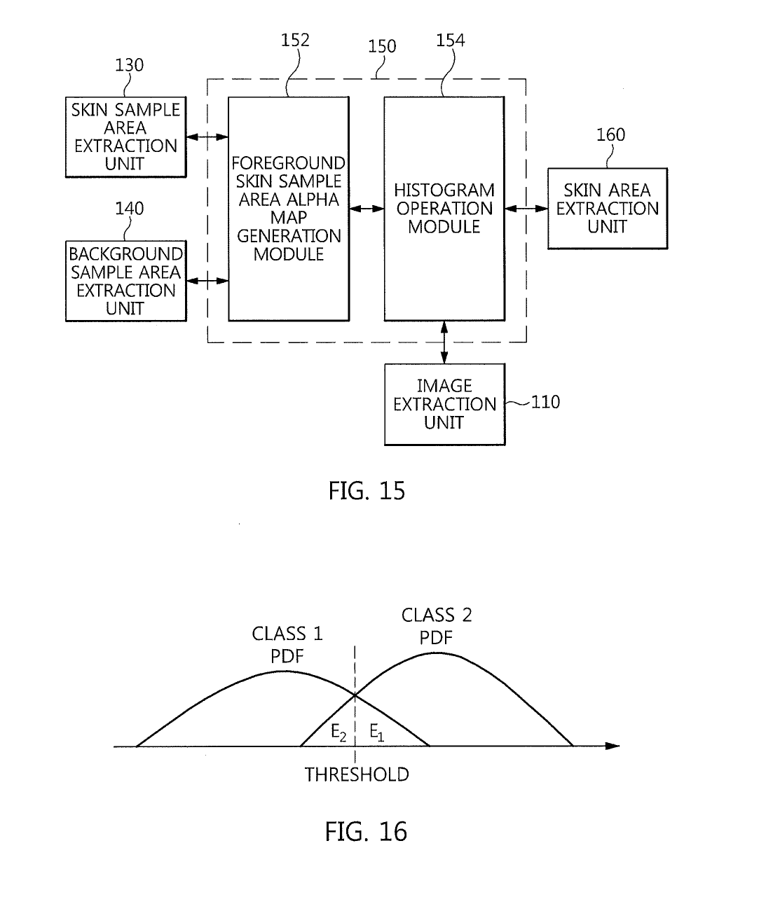

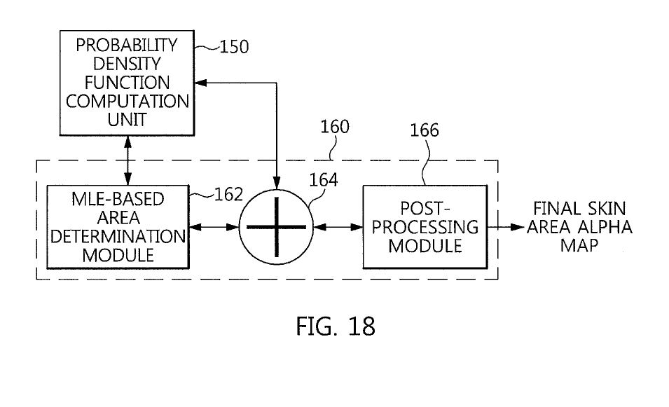

An apparatus for extracting a skin area to block a harmful content image according to an embodiment of the present invention will be described in greater detail below with reference to the accompanying drawings. FIG. 3 is a block diagram illustrating an apparatus for extracting a skin area to block a harmful content image according to an embodiment of the present invention. FIGS. 4 to 9 are diagrams illustrating the skin sample area extraction unit of FIG. 3, FIGS. 10 to 14 are diagrams illustrating the background sample area extraction unit of FIG. 3, FIGS. 15 to 17 are diagrams illustrating the probability density function computation unit of FIG. 3, and FIG. 18 is a diagram illustrating the skin area extraction unit of FIG. 3.

As illustrated in FIG. 3, an apparatus 100 for extracting a skin area to block a harmful content image includes an image extraction unit 110, a storage unit 120, a skin sample area extraction unit 130, a background sample area extraction unit 140, a probability density function computation unit 150, and a skin area extraction unit 160.

The image extraction unit 110 extracts frame-based images from image media 200. That is, the image extraction unit 110 loads the image media 200 (that is, a moving image, an image, etc.) provided through network storage, local storage, real-time streaming service and/or the like into memory. The image extraction unit 110 extracts images from the image media 200 loaded into the memory on a frame basis. In this case, the image extraction unit 110 may extract images by performing sampling at specific intervals along a time axis in order to reduce the amount of data of extracted images because a general HD-level moving image includes 24 to 30 frames per second and a one or more hour moving image includes tens of thousands of frames.

The image extraction unit 110 transmits the extracted images to the skin sample area extraction unit 130, the background sample area extraction unit 140, the probability density function computation unit 150, and the skin area extraction unit 160. In this case, the image extraction unit 110 may convert the extracted images into a set size and/or format and then transmit them because the image media 200 may have various sizes and/or formats.

The storage unit 120 stores the obtained prior information of harmful content images. That is, the storage unit 120 stores previously obtained prior information including skin colors included in harmful content images. In this case, the storage unit 120 may selectively store various types of prior information, such as a probability density function, information about the distribution range of a simple skin color, a histogram, etc. inferred from previously obtained learning images, in accordance with the implementation method of the skin sample area extraction unit 130, as in the existing Jones' scheme.

The skin sample area extraction unit 130 extracts a skin sample area based on the images extracted by the image extraction unit 110 and the prior information stored in the storage unit 120. That is, the skin sample area extraction unit 130 extracts an skin sample area that is used for the probability density function computation unit 150 to calculate the probability density function of a skin area based on the image and the prior information (for example, a histogram, the distribution range of a skin color, etc.).

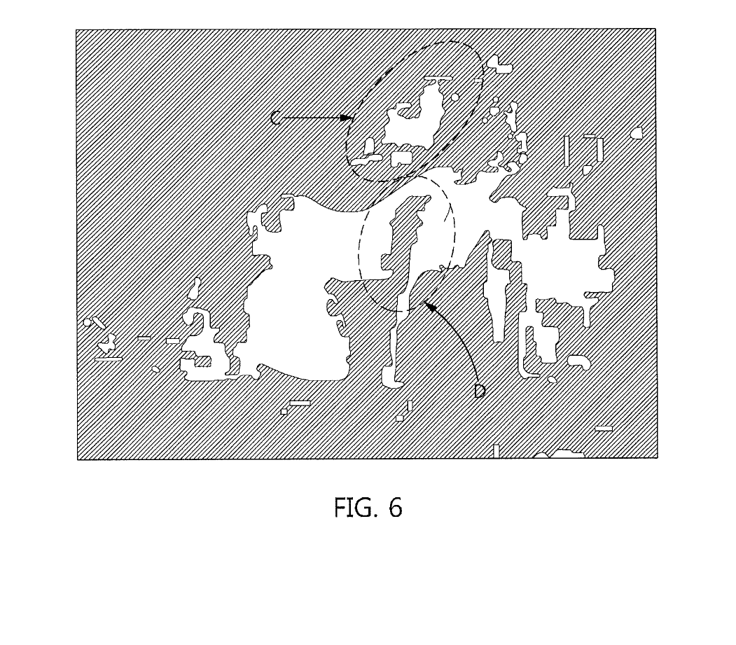

In this case, the skin sample area extraction unit 130 extracts the skin area using a binary alpha map that is generated by applying the Jones' scheme or a threshold value in a color space to the extracted image. As a result, the skin sample area extraction unit 130 generates a skin area (a true positive area) in which a skin area has been normally extracted, a background area (a true negative area) in which a background area has been normally extracted, an erroneously detected area (a false positive area) in which a background area has been extracted as a skin area, and an undetected area (a false negative area) in which a skin area has been extracted as a background area. By way of example, taking an image illustrated in FIG. 4 as an example, the skin sample area extraction unit 130 generates a true positive area (“A” of FIG. 5) and a true negative area (“B” of FIG. 5) in which a skin or a background has been normally recognized, and a false positive area (“C” of FIG. 6) and a false negative area (“D” of FIG. 6) in which a skin or a background has been abnormally recognized.

In this case, a false positive area included in the extracted skin sample area will be eliminated through a subtraction operation performed in connection with the background sample area, that is, the results of the operation of the background sample area extraction unit 140. Accordingly, the skin sample area extraction unit 130 extracts a skin sample area in order to minimize false negative rate while allowing false positive rate in a specific range. That is, since the false positive area is not included in a skin area alpha map skin area finally extracted by the extraction unit 160 if a larger number of sample pixels having similar color values in the corresponding area are extracted by the background sample area extraction unit 140, the false positive area is generally a problem. In contrast, in the case of a false negative area isolated within a skin area, false negative rate is minimized by making correction so that the false negative area is included in a skin sample area in order to improve the accuracy of the probability density function of a skin area calculated by the probability density function computation unit 150.

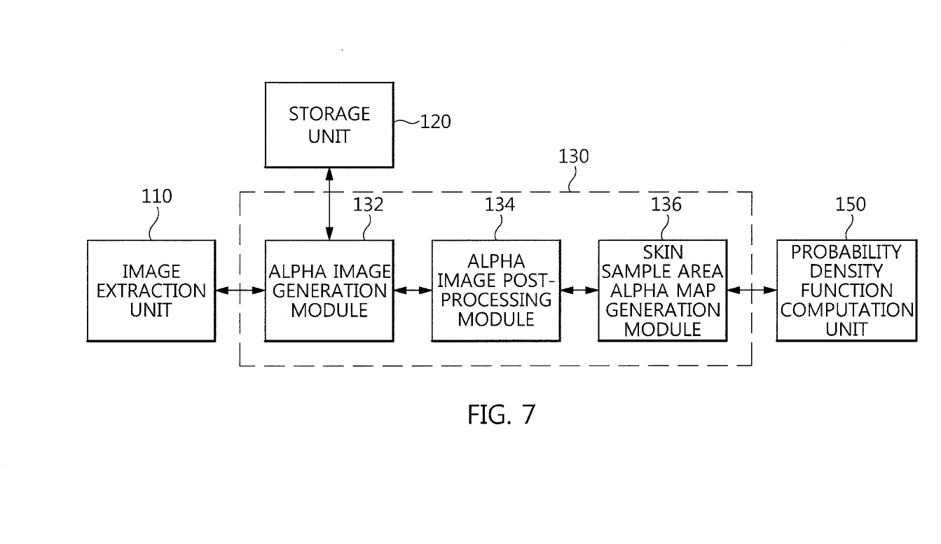

For this purpose, as illustrated in FIG. 7, the skin sample area extraction unit 130 includes an alpha image generation module 132, an alpha image postprocessing module 134, and a skin sample area alpha map generation module 136.

The alpha image generation module 132 generates a gray image-type alpha image for the image extracted by the image extraction unit 110 based on the prior information stored in the storage unit 120. In this case, the alpha image generation module 132 generates a gray image-type alpha image having continuous values in the range of 0 to 1.0 or 0 to 255.0 with respect to respective pixels of the extracted image. In this case, the alpha map is different from a conventional binary alpha map in that the intensity at each pixel means a continuous probability value indicative of the probability of the corresponding pixel belonging to a skin area.

The alpha image generation module 132 calculates an alpha value for each pixel of the extracted image using the following Equation 1:

AlphaImage(x,y)=255.0×Trunc(HistSkin(C(x,y))−HistNonSkin(C(c,y))) (1)

where AlphaImage(x, y) is the intensity of an alpha image at coordinates (x,y), C(x, y) is a color vector value at coordinates (x,y), HistSkin(C) is a skin area probability density function value for color C, HistNonSkin(C) is a non-skin area (that is, background area) probability density function value, and Trunc( ) is a function that returns an input value without change for a value equal to or larger than 0 and returns 0 for a value smaller than 0.

In this case, the alpha image generation module 132 may calculate an alpha value for each pixel of the extracted image using the following Equation 2. That is, the alpha image generation module 132 converts the extracted image into a color space, such as an HSV or YCbCr color space. The alpha image generation module 132 considers pixels each having a color value within a threshold range on a specific color axis or a few color axes in the corresponding color space to belong to a skin area. The alpha image generation module 132 approximately extracts pixels that are estimated to belong to a skin area. The alpha image generation module 132 may calculate alpha values by calculating the average value of the extracted skin area candidate pixels and a standard deviation and substituting them into the following Equation 2:

AlphaImage(x,y)=Trunc(k×σ_{c},−C(x,y)−m_{c}) (2)

where AlphaImage(x,y) is the intensity of an alpha image at coordinates (x,y), C(x,y) is a color vector value at coordinates (x,y), Trunc( ) is a function that returns an input value without change for a value equal to or larger than 0 and returns 0 for a value smaller than 0, k is an empirically determined constant value, σ_{c} is the standard deviation of the pixels of color C, and m_{c} is the average value of the pixels of color C.

The alpha image postprocessing module 134 corrects pixels included in the false negative area of the alpha image generated by the alpha image generation module 132. That is, the alpha image postprocessing module 134 increases the alpha values of the pixels of the false negative area (“D” of FIG. 6) that, in an alpha image, satisfies a set condition and is classified as a background area. Accordingly, the brightness of the alpha image is corrected such that some of the pixels included in the false negative area are detected as belonging to a skin area. In this case, the alpha image postprocessing module 134 corrects brightness on the assumption that an area which is isolated within an area of the alpha image classified as a skin area, an area whose three sides are adjacent to a skin area and whose alpha image brightness values are classified as a skin area, and an area which has similar brightness values and which is considered to be a background area because of slight differences are target pixels. As an example, when existing morphological closing operations (that is, a dilation operation and an erosion operation) are performed in the alpha image (that is, the alpha map of FIG. 6) generated by the alpha image generation module 132, the false negative area (“D” of FIG. 6) is eliminated. However, a problem arises in that the false positive rate increases in the background area (“B” of FIG. 5) instead. Accordingly, the alpha image postprocessing module 134 corrects the alpha image in order to reduce the false negative area in the gray image-type alpha image while preventing the above problem of the conventional technology. That is, the alpha image postprocessing module 134 corrects the brightness values of pixels included in the shoulder portion (that is, “D” of FIG. 6) of a model. In this case, when the alpha values of the background area (“B” of FIG. 5) are increased, the false positive area is increased and thus the accuracy of detection of the skin area is reduced. Accordingly, in the case where the difference in color is significant, as in the background area (“B” of FIG. 5) between the arm and thigh of the model, the alpha image postprocessing module 134 does not increase alpha values even when the three or more sides of an area in question are surrounded by a skin area.

The alpha image postprocessing module 134 increases the samples of the skin area in the alpha image generated by the alpha image generation module 132. That is, the alpha image postprocessing module 134 increases the samples of the skin area in the alpha image in order to improve the accuracy of the skin area probability density function computed by the probability density function computation unit 150. In this case, the alpha image postprocessing module 134 increases the alpha values of respective pixels that satisfy a specific condition and belong to the pixels included in the skin area in order to reduce the false negative ratio (FNR) at the skin sample area alpha map generation module 136.

In this case, the alpha image postprocessing module 134 performs morphological operations on values within a specific condition using conditional morphology closing operation. That is, the alpha image postprocessing module 134 uses conditional morphology closing operations that perform dilation and erosion operations only if the difference between a current pixel value and the maximum value or minimum value within a window falls within a specific range in the gray image-type alpha image. In this case, the conditional morphology closing operations sequentially apply a conditional morphology dilation operation and a conditional morphology erosion operation, a detailed method of which will be described below.

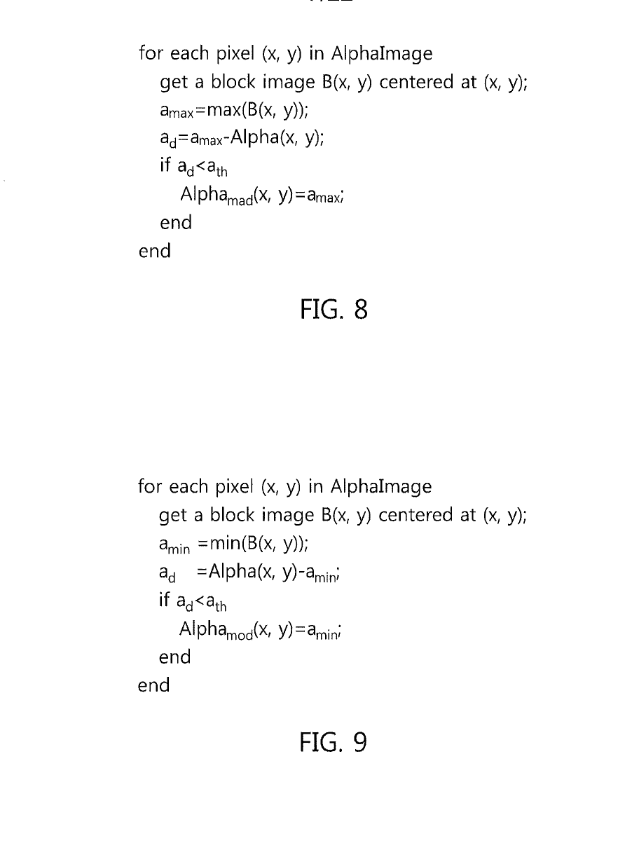

First, the alpha image postprocessing module 134 performs a conditional morphology dilation operation on a gray image (that is, an alpha image) using an algorithm illustrated in FIG. 8. The alpha image postprocessing module 134 performs a conditional morphology erosion operation on the gray image (that is, the alpha image) using an algorithm illustrated in FIG. 9. In this case, in FIGS. 8 and 9, B(x,y) is an extracted block image centered at current pixel coordinates (x,y), and max( ) returns the maximum value within the extracted block image. Alpha(x,y) is an input alpha image, Alpha_{mod}(x,y) is a corrected alpha image, and aₜₕ is an empirically determined constant.

The alpha image postprocessing module 134 sequentially applies the above-described two operations (that is, the conditional morphology dilation operation and the conditional morphology erosion operation) to the generated alpha image, thereby producing the effect of increasing the brightness of an area that, in the alpha image, is surrounded by bright pixels having brightness values equal to or larger than a threshold value and has brightness values slightly lower than the threshold value (that is, an area that leads to a false negative area if it is classified based on the threshold value). As a result, the alpha image postprocessing module 134 enables part of an area that is surrounded by a skin area and is not detected because of slight differences, such as a false negative area, to be extracted as a skin area, and, simultaneously, prevents the phenomenon in which a background area surrounded by a skin area is erroneously detected as a skin area within a certain range.

The skin sample area alpha map generation module 136 considers pixels having alpha values equal to or larger than a specific value in the alpha image corrected by the alpha image postprocessing module 134 to belong to a skin area, and generates a binary skin sample area alpha map.

The background sample area extraction unit 140 extracts a background sample area based on the image extracted by the image extraction unit 110 and the prior information stored in the storage unit 120. For this purpose, as illustrated in FIG. 10, the background sample area extraction unit 140 includes an edge-based background sample area extraction module 143, a peripheral background sample area extraction module 146, and a summation module 147.

The edge-based background sample area extraction module 143 generates an edge-based background alpha map on the assumption that a smaller number of edges are distributed on a skin area of a human than a background. In this case, the edge-based background sample area extraction module 143 generates an edge-based background alpha map based on the background area extracted from the image extracted by the image extraction unit 110. For this purpose, the edge-based background sample area extraction module 143 includes an edge operation module 141 and an edge density-based background block determination module 142.

The edge operation module 141 calculates edge components at respective pixels using an edge operator, such as a Sobel edge operator. The edge operation module 141 generates a binary edge map by mapping an edge component belonging to the calculated edge components and having value equal to or larger than a specific threshold value to 1 and an edge component having a value lower than the threshold value to 0.

The edge density-based background block determination module 142 generates an edge density-based background alpha map that distinguishes a skin area and a background area from each other in each block, based on an edge map generated by the edge operation module 141.

The edge density-based background block determination module 142 segments the image into blocks having a size of m_{EB}*n_{EB}. The edge density-based background block determination module 142 sums the binary edge values of each of the blocks.

The edge density-based background block determination module 142 determines a block having a sum equal to or larger than a set value to be a background area block. The edge density-based background block determination module 142 assigns 1 to every pixel of a block that is determined to be a background area block. The edge density-based background block determination module 142 determines a block having a sum lower than the set value to be a skin area block. The edge density-based background block determination module 142 assigns 0 to every pixel of a block that is determined to be a skin area block. As described above, the edge density-based background block determination module 142 generates an edge-based background alpha map by assigning 0 or 1 to each of the pixels through the comparison between the sum and the set value.

The peripheral background sample area extraction module 146 generates a peripheral background area alpha map on the assumption that an area that has a consistent color distribution over a wide range in the left, right and upper end edge areas of the image extracted by the image extraction unit 110 has a strong possibility of belonging to a background area. For this purpose, the peripheral background sample area extraction module 146 includes a peripheral area block-based color distribution operation module 144 and a peripheral background block determination module 145.

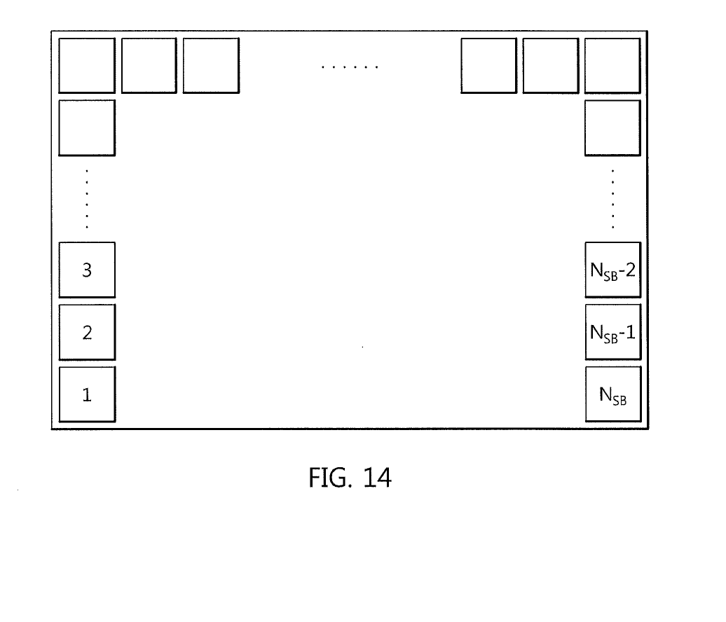

The peripheral area block-based color distribution operation module 144 segments the image into a plurality of blocks, and calculates a color distribution histogram in each of the peripheral blocks. That is, as illustrated in FIG. 14, the peripheral area block-based color distribution operation module 144 segments the left, right and upper end edge area of the image into N_{SB} peripheral blocks SB that have a size of m_{SB}*n_{SB} and are assigned sequential indices. The peripheral area block-based color distribution operation module 144 calculates a color distribution histogram in each of the peripheral blocks.

The peripheral background block determination module 145 calculates color distribution errors with respect to the peripheral blocks (i.e., SBₖ, k≠i) other than each of the peripheral blocks SBᵢ segmented by the peripheral area block-based color distribution operation module 144. The peripheral background block determination module 145 determines corresponding blocks to be blocks having similar color distributions if a calculated color distribution error is equal to or lower than a set value. The peripheral background block determination module 145 considers a current peripheral block SBᵢ to be a peripheral block that belongs to a background area if a reference function f_{SB} proportional to the number and distribution range of blocks classified as similar blocks is equal to or larger than a set value.

In this case, the peripheral background block determination module 145 calculates a reference function f_{SB} using the following Equation 3. In this case, Equation 3 is an example of the reference function f_{SB}. In actual implementation, a reference function f_{SB} that calculates a value proportional to the number and distribution range of blocks having similar color distributions and that is suitable for the extraction of a background area based on the above-described assumption of the peripheral background sample area extraction module 146 can achieve the above-described effect of the present invention in the same manner.

ƒ_{SB}(Xᵢ)=K×Nₓ_{ᵢ}×σᵢ

Xᵢ={SBₖ|Dist(Hist(SBᵢ),Hist(SBₖ))<th_{SB,Hist}}

Iᵢ={k|SBₖεXᵢ}

N_{X}_{ᵢ}=size(Iᵢ)

σᵢ=std(Iᵢ) (3)

where k is a proportional constant, Hist(SBᵢ) is the color distribution histogram of the peripheral block SBᵢ, Dist(H1, H2) is an error function between histograms H1 and H2, size(X) is the number of elements of set X, and std(X) is the standard deviation of the elements of set X.

The peripheral background block determination module 145 repeatedly performs the above-described operation on every block (i.e., SBᵢ, i=1 to N_{SB}). The peripheral background block determination module 145 generates a peripheral background area alpha map by assigning 1 to pixels within each block belonging to a background area and assigning 0 to all pixels within all the other blocks and all pixels of an inside area not assigned to the peripheral blocks.

The summation module 147 generates a background sample area alpha map by summing the edge-based background area alpha map generated by the edge-based background sample area extraction module 143 and the peripheral background area alpha map generated by the peripheral background sample area extraction module 146. In this case, the summation module 147 sums the edge-based background area alpha map and the peripheral background area alpha map by performing an OR operation thereon.

In this case, if the probability density function computation unit 150 to be described later uses only the above-described edge-based background alpha map in order to estimate the probability density function of a background area, an area having few edge components, such as a single-color wall background, is not extracted as a background area. As a result, the probability density function of a background area calculated by the probability density function computation unit 150 has the problem of having a bias in which density concentrates on the color of a background in which edge components are densely disposed.

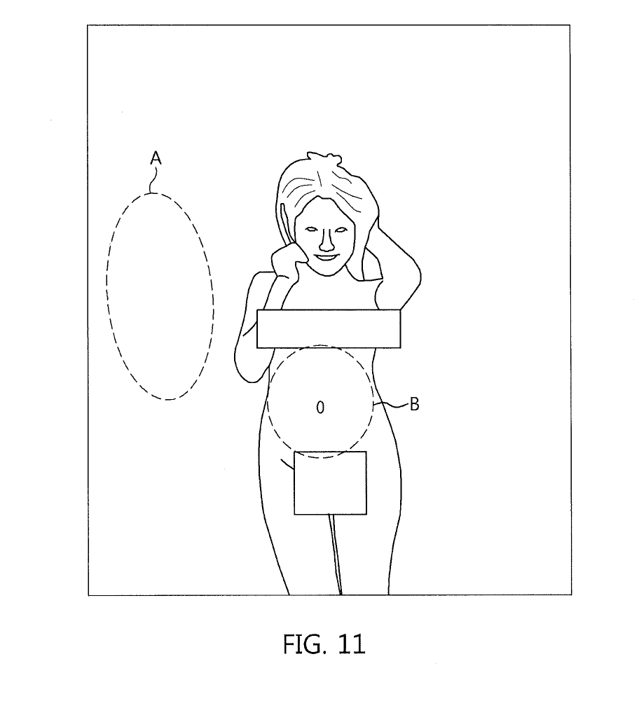

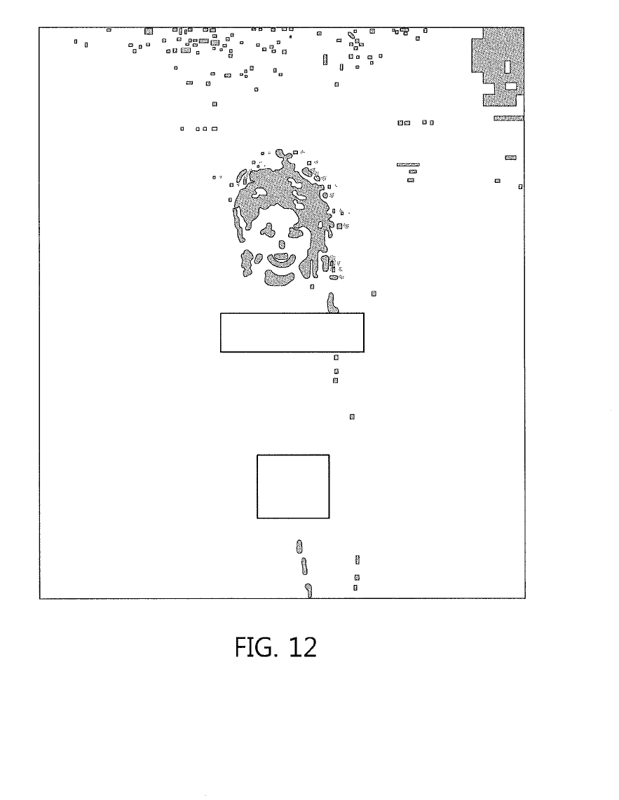

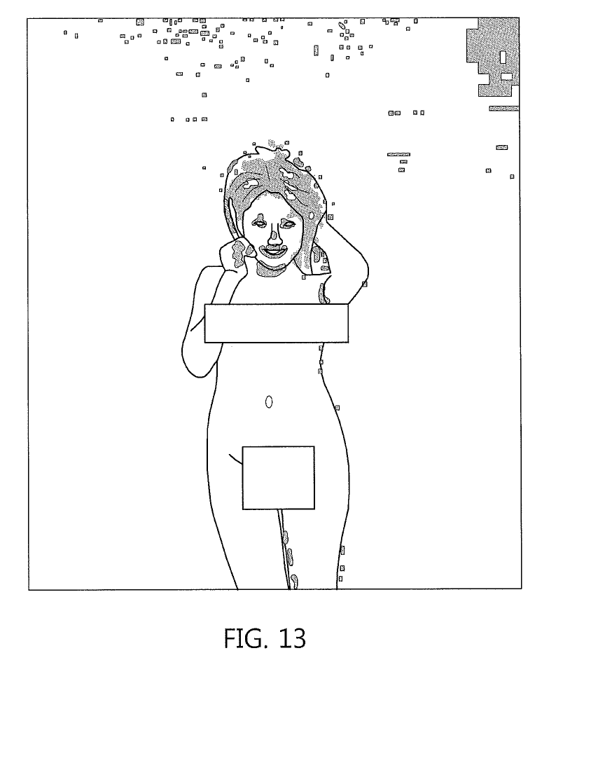

As an example, if an edge-based background alpha map (i.e., the image of FIG. 12) is generated using an image (i.e., the image of FIG. 11), area E of a background is not extracted as a background area by the edge-based background sample area extraction module 143 because area E has a color similar to that of area F, that is, an actual skin area, and has few edge components. As a result, if a background area, such as area E, included only in a skin sample area alpha map passes through the probability density function computation unit 150 and the skin area extraction unit 160, a considerable part of a background area is included in a finally extracted skin area, as illustrated in FIG. 13. That is, when a single color background having a red tone similar to that of a skin color is included in an image, considerable part of a wall background is included and detected in a skin sample area alpha map. Accordingly, if the probability density function of a background area is calculated using only an edge-based background alpha map as a background area sample alpha map and passing through the skin area extraction unit 160 is performed, an erroneously detected background is included in a final skin area alpha map without change. In order to overcome the above problem, the peripheral background sample area extraction module 146 is further included so as to include part of a background having few edge components in a background area sample alpha map.

The above-described skin sample area extraction unit 130 and background sample area extraction unit 140 are intended to obtain a sample area that is used for the probability density function computation unit 150 to estimate a probability density function for a skin area color distribution and a probability density function for a background area color distribution with respect to an image. Accordingly, a skin sample area alpha map and a background sample area alpha map generated by the skin sample area extraction unit 130 and the background sample area extraction unit 140 do not need to include both an actual skin area and the actual area of a background area. The ideal condition of each sample alpha map of this step is to ensure a sufficient amount of sample data in order to allow color components included in a corresponding area to have a higher rate of probability density than those of a counterpart area to minimize loss at the skin area extraction unit 160.

The probability density function computation unit 150 calculates the probability density function of the skin sample area extracted by the skin sample area extraction unit 130 and the probability density function of the background sample area extracted by the background sample area extraction unit 140. That is, the probability density function computation unit 150 calculates the probability density function of each area included in the image in the form of a histogram using the skin sample area and the background sample area. For this purpose, as illustrated in FIG. 15, the probability density function computation unit 150 includes a foreground skin sample area alpha map generation module 152, and a histogram operation module 154.

The foreground skin sample area alpha map generation module 152 generates a foreground skin sample area alpha map in which overlaps between the skin sample area alpha map and the background sample area alpha map have been eliminated from the skin sample area alpha map.

The histogram operation module 154 calculates the histogram of the foreground skin sample area alpha map generated by the foreground skin sample area alpha map generation module 152 and the histogram of the background sample area alpha map.

The following advantages that are achieved by estimating probability density functions in the sample areas (i.e., the foreground skin sample area, the skin sample area, and the background sample area) extracted from the image in the proposed method, rather than by using the probability density functions of the skin area and the background area estimated from learning data in advance in the existing Jones' scheme are as follows.

FIG. 16 is a diagram illustrating an example of a loss section in the case of MLE. When the probability density functions (PDFs) of Class 1 and Class 2 are as illustrated in the drawing, an area included in E1 and E2 is proportional to the amount of error in which erroneous determination is performed in Class 1 and Class 2. If the probability density functions of the skin area and the background area are estimated from a large amount of learning data in advance, the estimated probability density functions are distributed over a considerably wide range.

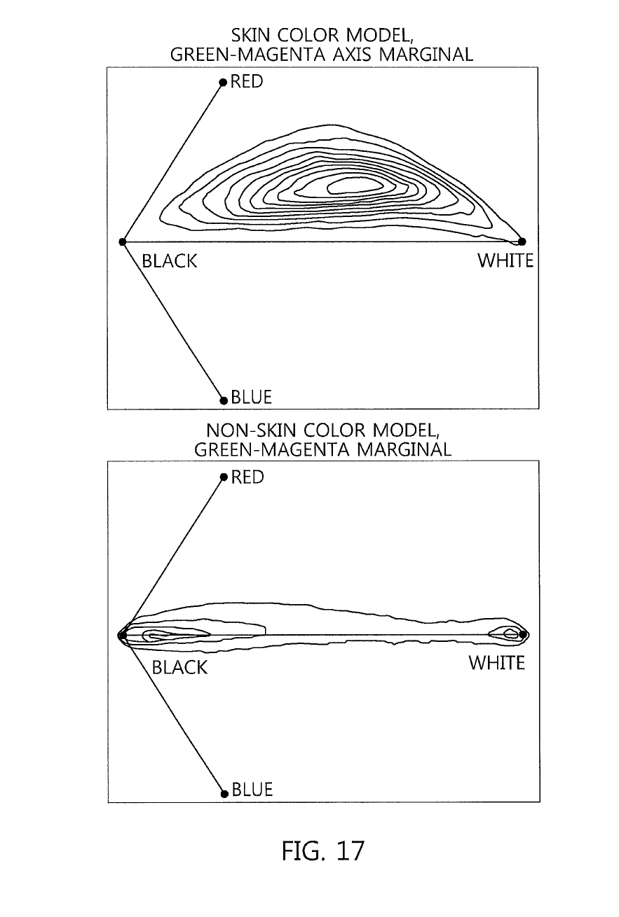

FIG. 17 is a diagram illustrating the probability density functions of a skin area and a background area that are estimated from learning data in advance using the Jones' scheme. As illustrated in FIG. 17, it can be seen that an overlap section is generated over a wide range in spite of the differences in the location and pattern of distribution. In this case, when a skin sample area alpha map and a background sample area alpha map are extracted from an image and a probability density function is estimated from each of the sample areas, as in the present invention, the estimated probability density functions are distributed over a narrower range to fit the current image, with the result that the amount of error is reduced in MLE.

The skin area extraction unit 160 extracts a skin area using an MLE method based on the probability density functions calculated by the probability density function computation unit 150. For this purpose, as illustrated in FIG. 18, the skin area extraction unit 160 includes an MLE-based area determination module 162, a multiplication module 164, and a postprocessing module 166.

The MLE-based area determination module 162 generates an MLE skin alpha map based on the histogram of the foreground skin sample area alpha map and the histogram of the background sample area alpha map calculated by the probability density function computation unit 150. That is, the MLE-based area determination module 162 considers the histogram of the foreground skin sample area alpha map to be the probability density function of a skin area class and the histogram of the background sample area alpha map to be the probability density function of a background area class. The MLE-based area determination module 162 generates an MLE skin alpha map by comparing the probability density function values of the skin area class and the background area class with respect to every pixel of the image. In this case, the MLE-based area determination module 162 generates an MLE skin alpha map by assigning 1 to pixels determined to belong to a skin area and assigning 0 to the other pixels using an MLE method that performs determination based on a class having a larger value in the same pixel.

The multiplication module 164 multiplies the MLE skin alpha map generated by the MLE-based area determination module 162 by the skin sample area alpha map.

The postprocessing module 166 generates a final skin area alpha map by eliminating noise components fragmentarily occurring in the alpha maps. In this case, the postprocessing module 166 may be implemented through morphological closing operations in a binary alpha map. The same effect of the present invention can be achieved even when a similar noise filtering method is employed.

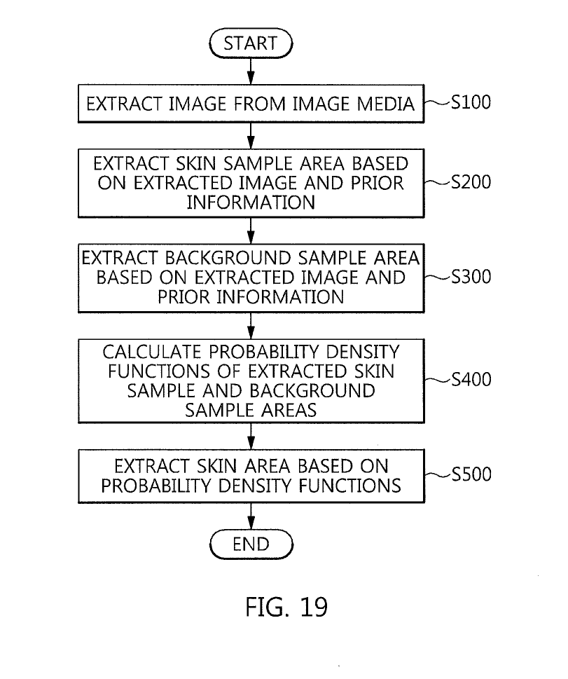

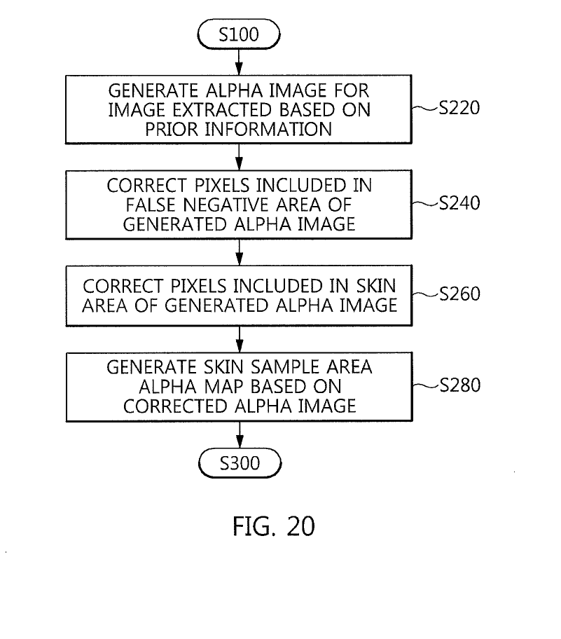

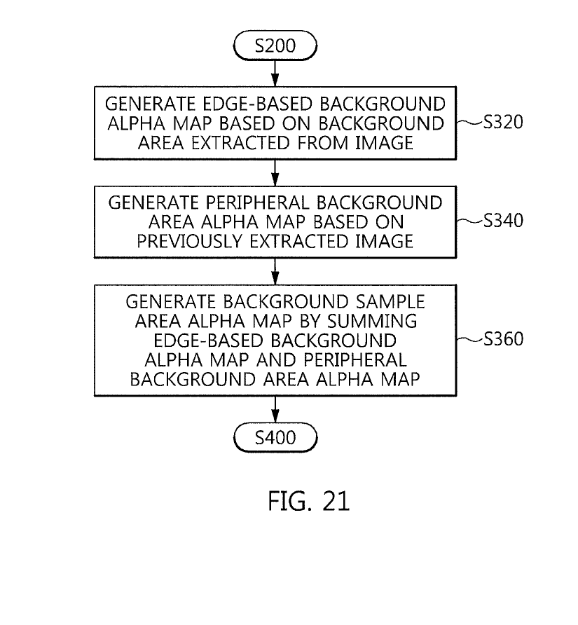

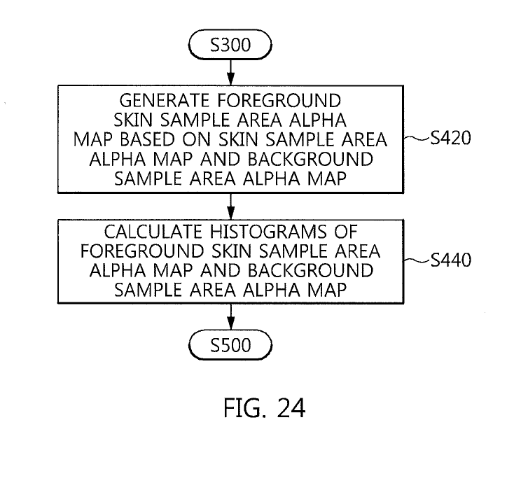

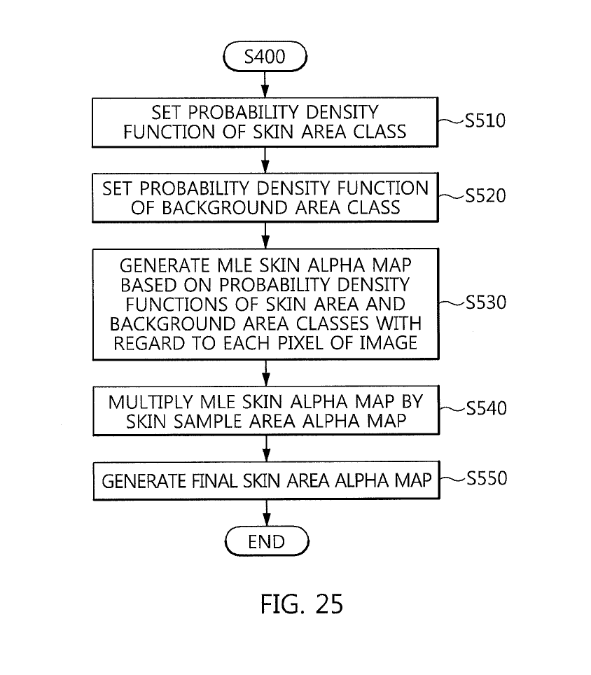

A method of extracting a skin area to block a harmful content image according to an embodiment of the present invention will be described in detail below with reference to the accompanying drawings. FIG. 19 is a flowchart illustrating a method of extracting a skin area to block a harmful content image according to an embodiment of the present invention. FIG. 20 is a flowchart illustrating the skin sample area extraction step of FIG. 19, FIGS. 21 to 23 are flowcharts illustrating the background sample area extraction step of FIG. 19, FIG. 24 is a flowchart illustrating the probability density function operation step of FIG. 19, and FIG. 25 is a flowchart illustrating the skin area extraction step of FIG. 19.

The image extraction unit 110 extracts images from image media 200 at step S100. That is, the image extraction unit 110 loads the image media 200 (that is, a moving image, an image, etc.) provided through network storage, local storage, real-time streaming service and/or the like into memory, and extracts images from the loaded image media 200 on a frame basis. In this case, the image extraction unit 110 may convert the extracted images into a set size and/or format because the image media 200 may have various sizes and/or formats.

The skin sample area extraction unit 130 extracts a skin sample area based on previously extracted images and previously stored prior information at step S200. That is, the skin sample area extraction unit 130 extracts an skin sample area that is used to calculate the probability density function of a skin area based on the image and the prior information (for example, a histogram, the distribution range of a skin color, etc.). In this case, the skin sample area extraction unit 130 generates a binary skin sample area alpha map. This will be described in detail below with reference to FIG. 20.

The skin sample area extraction unit 130 generates a gray image-type alpha image for the previously extracted image based on the previously stored prior information at step S220. That is, the skin sample area extraction unit 130 generates a gray image-type alpha image having continuous values in the range of 0 to 1.0 or 0 to 255.0 for respective pixels of the extracted image. In this case, the skin sample area extraction unit 130 calculates the intensity of the alpha image for each pixel of the image, and sets an alpha value for each pixel.

The skin sample area extraction unit 130 corrects pixels included in the false negative area of the previously generated alpha image at step S240. That is, the skin sample area extraction unit 130 increases the alpha values of the pixels of a false negative area that, in the alpha image, satisfies a set condition and is classified as a background area so that some of the pixels included in the false negative area are detected as belonging to a skin area. In this case, the skin sample area extraction unit 130 corrects brightness on the assumption that an area which is isolated within an area of the alpha image classified as a skin area, an area whose three sides are adjacent to a skin area and whose alpha image brightness values are classified as a skin area, and an area which has similar brightness values and which is considered to be a background area because of slight differences are target pixels.

The skin sample area extraction unit 130 corrects pixels included in a skin area of the previously generated alpha image at step S260. That is, the skin sample area extraction unit 130 increases the alpha values of pixels that satisfy a specific condition and belong to the pixels included in the skin area. In this case, the skin sample area extraction unit 130 corrects the pixels included in the skin area using conditional morphology closing operations that perform dilation and erosion operations only if the difference between a current pixel value and the maximum value or minimum value within a window falls within a specific range in the alpha image. Through this, the skin sample area extraction unit 130 increases the brightness of an area that, in the alpha image, is surrounded by bright pixels having brightness values equal to or larger than a threshold value and has brightness values slightly lower than the threshold value (that is, an area that leads to a false negative area if it is classified based on the threshold value).

The skin sample area extraction unit 130 generates a skin sample area alpha map based on the corrected alpha image at step S280. That is, the skin sample area extraction unit 130 generates a binary skin sample area alpha map by considering pixels each having an alpha value equal to or larger than a specific value to belong to a skin area in the alpha image.

The background sample area extraction unit 140 extracts a background sample area based on the previously extracted image and the previously stored prior information at step S300. This will be described in greater detail below with reference to FIG. 21.

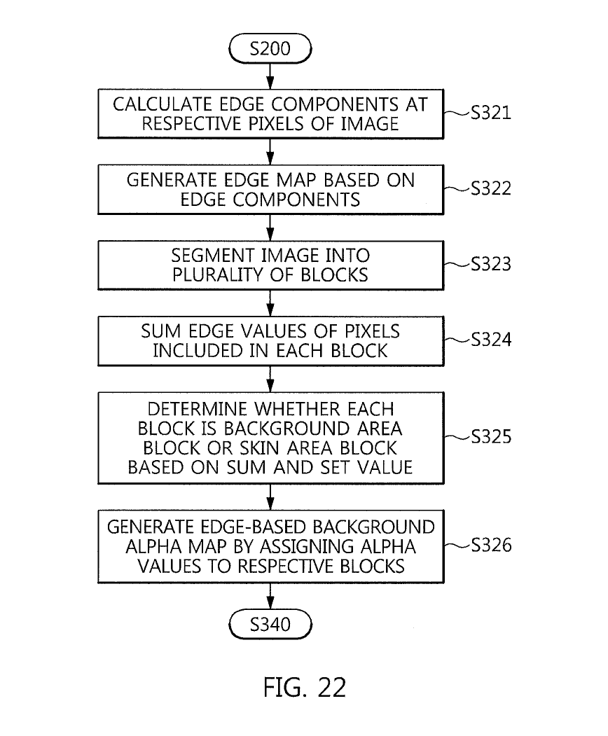

The background sample area extraction unit 140 generates an edge-based background alpha map based on the background area extracted from the extracted image at step S320. That is, the background sample area extraction unit 140 generates an edge-based background alpha map on the assumption that a smaller number of edges are distributed on a skin area of a human than a background. In this case, the background sample area extraction unit 140 generates the edge-based background alpha map based on the background area extracted from the extracted image. This will be described in greater detail below with reference to FIG. 22.

The background sample area extraction unit 140 calculates edge components at respective pixels using an edge operator at step S321.

The background sample area extraction unit 140 generates a binary edge map based on the previously calculated edge components at step S322. That is, the background sample area extraction unit 140 generates a binary edge map by mapping 1 to each pixel that belongs to the previously calculated edge components and has an edge component equal to or higher than a specific threshold value as an edge value and mapping 0 to a pixel having a value lower than the specific threshold value as an edge value.

The background sample area extraction unit 140 segments the image into a plurality of blocks at step S323, and sums the edge values of pixels included in each of the blocks at step S324. That is, the background sample area extraction unit 140 segments the image into blocks having a size of m_{EB}*n_{EB}. The background sample area extraction unit 140 sums the binary edge values of the respective blocks.

The background sample area extraction unit 140 determines each of the blocks to be a background area block or a skin area block by comparing the sum with a set value at step S325. In this case, the background sample area extraction unit 140 determines a block to be a background area block if the sum of the block (i.e., the sum of the edge values of pixels included in the block) is equal to or larger than the set value. In contrast, the background sample area extraction unit 140 determines a block to be a skin area block if the sum of the block is lower than the set value.

The background sample area extraction unit 140 generates an edge-based background alpha map by assigning alpha values to the background area and skin area blocks at step S326. That is, the background sample area extraction unit 140 generates an edge-based background alpha map by assigning 1 to all pixels within a block determined to be a background area block and assigning 0 to all pixels within a block determined to be a skin area block.

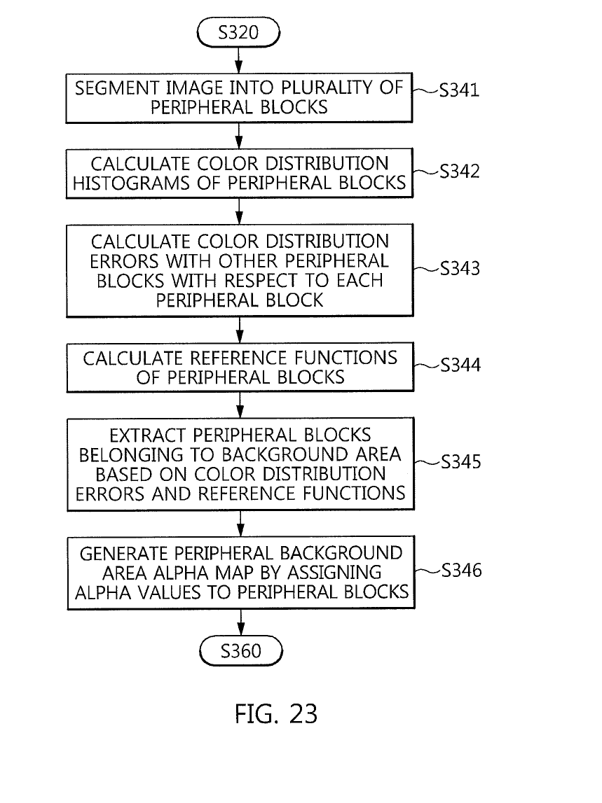

The background sample area extraction unit 140 generates a peripheral background area alpha map based on the previously extracted image at step S340. That is, the background sample area extraction unit 140 generates a peripheral background area alpha map on the assumption that an area that has a consistent color distribution over a wide range in the left, right and upper end edge areas of the image extracted by the image extraction unit 110 has a strong possibility of belonging to a background area. This will be described in greater detail below with reference to FIG. 23.

The background sample area extraction unit 140 segments the image into a plurality of peripheral blocks at step S341. That is, the background sample area extraction unit 140 segments the left, right and upper end edge area of the image into N_{SB} peripheral blocks SB that have a size of m_{SB}*n_{SB} and are assigned sequential indices.

The background sample area extraction unit 140 calculates a color distribution histogram in each of the peripheral blocks at step S342.

The background sample area extraction unit 140 calculates the color distribution errors of each peripheral block with respect to other peripheral blocks at step S343. That is, the background sample area extraction unit 140 calculates color distribution errors with respect to the peripheral blocks (i.e., SBₖ, k≠i) other than each of the segmented peripheral blocks SBᵢ.

The background sample area extraction unit 140 calculates the reference functions f_{SB} of the peripheral blocks at step S344. That is, the background sample area extraction unit 140 calculates reference functions that are proportional to the color distribution ranges of the peripheral blocks.

The background sample area extraction unit 140 extracts the peripheral blocks belonging to the background area based on the color distribution errors and reference functions of the peripheral blocks at step S345. That is, the background sample area extraction unit 140 determines corresponding blocks to be blocks having similar color distributions if the calculated color distribution errors are equal to or lower than a set value. The background sample area extraction unit 140 extracts blocks as peripheral blocks belonging to a background area if the number and reference function of blocks having similar color distributions are equal to or larger than a set value.

The background sample area extraction unit 140 generates a peripheral background area alpha map by assigning alpha values to the peripheral blocks at step S346. That is, the background sample area extraction unit 140 generates a peripheral background area alpha map by assigning 1 to pixels within the blocks belonging to the background area as an alpha value and assigning 0 to all pixels within all the other peripheral blocks and all the pixels of an inside area not assigned to the peripheral blocks.

The background sample area extraction unit 140 generates a background sample area alpha map by summing the edge-based background alpha map and the peripheral background area alpha map at step S360. That is, the background sample area extraction unit 140 performs an OR operation on the edge-based background area alpha map and the peripheral background area alpha map.

The probability density function computation unit 150 calculates the probability density functions of the previously extracted skin sample and background sample areas at step S400. That is, the probability density function computation unit 150 calculates the probability density functions of respective areas included in the image in the form of histograms using the skin sample and background sample areas. This will be described in greater detail below with reference to FIG. 24.

The probability density function computation unit 150 generates a foreground skin sample area alpha map in the skin sample area alpha map based on the background sample area alpha map at step S420. That is, the probability density function computation unit 150 generates a foreground skin sample area alpha map in which an overlap between the skin sample area alpha map and the background sample area alpha map has been eliminated from the skin sample area alpha map.

The probability density function computation unit 150 calculates the histogram of the previously generated foreground skin sample area alpha map and the histogram of the previously generated background sample area alpha map at step S440.

The skin area extraction unit 160 extracts a skin area based on the previously calculated probability density functions at step S500. The skin area extraction unit 160 extracts a skin area using an MLE method based on the previously calculated probability density functions. This will be described in greater detail below with reference to FIG. 25.

The skin area extraction unit 160 sets the histogram of the foreground skin sample area alpha map as the probability density function of a skin area class at step S510.

The skin area extraction unit 160 sets the histogram of the background sample area alpha map as the probability density function of the background area class at step S520.

The skin area extraction unit 160 generates an MLE skin alpha map by comparing the probability density function of the skin area class with the probability density function of the background area class with respect to each of the pixels of the image at step S530. In this case, the skin area extraction unit 160 generates an MLE skin alpha map by assigning 1 to pixels determined to belong to a skin area and assigning 0 to the other pixels using an MLE method that performs determination based on a class having a larger value in the same pixel.

The skin area extraction unit 160 multiplies the previously generated MLE skin alpha map by the previously generated skin sample area alpha map at step S540, and eliminates a noise component at step S550, thereby generating a final skin area alpha map. In this case, the skin area extraction unit 160 eliminates a noise component through morphological closing operations in the binary alpha map. It will be apparent that the skin area extraction unit 160 may employ another noise filtering method similar to the morphological closing operations.

As described above, the present invention provides a two-step method of, in order to overcome the limitation of the conventional learning-based skin area extraction method, estimating the probability density functions of a skin area and a background area (that is, a non-skin area) from an input image and extracting a skin area using an MLE method. At a first step, a skin sample area alpha map and a background area sample alpha map are generated in order to extract sample data used to calculate probability density functions, and at a second step, a skin area is extracted using an MLE method.

In the skin sample area alpha map generation process of the first step, in order to expand an area not detected because of slight differences to a skin area while suppressing an increase in false positive rate, an alpha image having continuous brightness values is generated, and a new type-conditional morphology closing operation method is presented. In contrast, in the existing skin extraction postprocessing method, the false negative rate is reduced and the false positive rate is increased in an area where color differences are clear because the existing skin extraction postprocessing method utilizes morphological operations in a binary alpha map.

Furthermore, in the background area sample alpha map generation process of the first step, a background sample area is extracted from an area having few edge components based on the repetitiveness of color distributions in a peripheral edge area using the prior knowledge of the composition of a harmful content image. In contrast, the conventional technology filters out a background area using only edge density. More specifically, the conventional skin area extraction method proposes a method of estimating a background area in order to filter out a background area mixed and detected in an extracted skin area. However, the conventional background area estimation method chiefly identifies an area having prominent high frequency components including edge components, considers this area to be a background area, and then performs filtering. With this conventional method, it is impossible to effectively extract a background area having a single color or smooth color gradation, such as an interior wall surface. In the present invention, an area having consistent color distributions in left, right and upper end edge areas is additionally included in a background area using the characteristics of harmful content images (that is, using prior knowledge indicating that there are many cases where the naked body of a human or a sexual act is chiefly displayed at the center of a screen center in order to fulfill sexual desires).

The MLE-based skin area extraction process of the second step is different from the conventional Jones' scheme in that while the conventional Jones' scheme extracts a skin area based on an MLE method using the previously learned probability density functions of a skin area and a background area, the present invention extracts a skin area based on an MLE method using the probability density functions of a skin area and a background area estimated from an image. More specifically, the prior learning-based MLE skin area extraction method (Jones, CVPR 1999) is disadvantageous in that a loss section in the results of MLE determination is wide because the prior learning-based method estimates probability density functions using an enormous amount of sample information about various artificial objects and natural objects from previously obtained learning data as data when estimating the color distribution of a background area, that is, a non-skin area other than a skin area. In contrast, the present invention can expect the effect of reducing the width of the loss section of MLE determination because the probability density function of a background area is estimated based on background area sample information extracted from an input image. Comparing the present invention with the conventional object detection-based skin area extraction method, the conventional method models a skin area color distribution based on detected object information and then extracts a skin area using a decision function method, whereas the present invention estimates the probability density function of a background area as well as the probability density function of a skin area and then extracts a skin area based on MLE.

As described above, the apparatus and method for extracting a skin area to block a harmful content image are configured to calculate the probability density functions of a skin area and a background area from an image and extract a skin area using an MLE method based on the calculated probability density functions, thereby achieving the advantage of improving the accuracy of the results of skin area extraction.

Furthermore, the apparatus and method for extracting a skin area to block a harmful content image are configured to extract a peripheral background sample area from an image and apply it to skin area extraction, thereby achieving the advantage of overcoming the problem in which when conventional prior learning-based technology, such as the Jones' scheme, is employed, a background area having a color similar to that of a skin and few edge components, such as a red tone wall background, is erroneously detected as a skin area and thus minimizing false positive rate.

Moreover, the apparatus and method for extracting a skin area to block a harmful content image are configured to calculate the probability density functions of a skin area and a background area from an image and extract a skin area using an MLE method based on the calculated probability density functions, thereby achieving the advantage of minimizing skin area extraction time because the apparatus and method do not require a separate object detection process, unlike conventional technologies that are configured to improve the accuracy of the extraction of a skin area by detecting a specific bodily portion, such as a face or eyes.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for extracting a skin area to block a harmful content image, comprising;
an image extraction unit configured to extract an image from image media;
a skin sample area extraction unit configured to extract a skin sample area of the image based on previously stored prior information;
a background sample area extraction unit configured to extract a background sample area of the image based on the prior information;
a probability density function computation unit configured to calculate a probability density function of the skin sample area and a probability density function of the background sample area; and
a skin area extraction unit configured to extract a skin area from the image based on the probability density functions of the skin sample area and the background sample area.

2. The apparatus of claim 1, wherein the skin sample area extraction unit comprises:
an alpha image generation module configured to generate a gray image-type alpha image for the image based on the prior information;
an alpha image postprocessing module configured to, in the alpha image, correct pixels included in a false negative area and pixels included in a skin area; and
a skin sample area alpha map generation module configured to generate a binary skin sample area alpha map based on the alpha image corrected by the alpha image postprocessing module.

3. The apparatus of claim 2, wherein the alpha image generation module generates the alpha image by calculating alpha values based on a color vector value at each coordinates, and a skin area probability density function value and a background area probability density function value for each color or based on a color vector value at each coordinates, a standard deviation of pixels of each color and an average value of pixels of each color and then assigning the alpha values to respective pixels included in the image.

4. The apparatus of claim 2, wherein on an assumption that an area which is isolated within an area of the alpha image classified as a skin area, an area whose three sides are adjacent to a skin area and whose brightness values are classified as a skin area, and an area which has similar brightness values and which is considered to be a background area are target pixels, the alpha image postprocessing module increases alpha values of pixels included in the corresponding areas.

5. The apparatus of claim 2, wherein the alpha image postprocessing module increases alpha values by performing a conditional morphology closing operation and a conditional morphology dilation operation on pixels of the alpha image which are included in a skin area and in which a difference between their pixel value and a maximum value or minimum value within a window falls within a specific range.

6. The apparatus of claim 1, wherein the background sample area extraction unit comprises:
an edge-based background sample area extraction module configured to generate an edge-based background alpha map based on a background area extracted from the image;
a peripheral background sample area extraction module configured to generate a peripheral background area alpha map based on the image; and
a summation module configured to generate a background sample area alpha map by summing the edge-based background alpha map and the peripheral background area alpha map.

7. The apparatus of claim 6, wherein the edge-based background sample area extraction module comprises:
an edge operation module configured to calculate edge components at respective pixels included in the image using an edge operator, and to generate a binary edge map by mapping an edge value to each of the pixels based on the edge components and a threshold value; and
an edge density-based background block determination module configured to segment the image into a plurality of blocks, to sum the edge values of pixels included in each of the blocks, and to generate an edge-based background alpha map by assigning alpha values to the respective pixels included in each of the blocks based on the sum of the edge values of each of the blocks and a set value.

8. The apparatus of claim 6, wherein the peripheral background sample area extraction module comprises:
a peripheral area block-based color distribution operation module configured to segment a left, right and upper end edge area of the image into a plurality of peripheral blocks, and to calculate a color distribution histogram of each of the peripheral blocks; and
a peripheral background block determination module configured to calculate color distribution errors with respect to other peripheral blocks and a reference function for each of the plurality of peripheral blocks, to detect a number of blocks having similar color distributions based on the color distribution errors, and to generate a peripheral background area alpha map by assigning alpha values to pixels included in the peripheral blocks based on the number of blocks having similar color distributions, the reference function and a set value.

9. The apparatus of claim 1, wherein the probability density function computation unit comprises:
a foreground skin sample area alpha map generation module configured to generate a foreground skin sample area alpha map in which an overlap area between the skin sample area alpha map generated by the skin sample area extraction unit and the background sample area alpha map generated by the background sample area extraction unit has been excluded from the background sample area alpha map generated by the background sample area extraction unit; and
a histogram operation module configured to calculate a histogram of the generated foreground skin sample area alpha map and a histogram of the background sample area alpha map.

10. The apparatus of claim 1, wherein the skin area extraction unit comprises:
an maximum-likelihood estimation (MLE)-based area determination module configured to generate an MLE skin alpha map of the image based on the histogram of the foreground skin sample area alpha map and the histogram of the background sample area alpha map calculated by the probability density function computation unit; and
a postprocessing module configured to generate a final skin area alpha map by eliminating noise components from an alpha map generated by multiplying the MLE skin alpha map by the skin sample area alpha map generated by the skin sample area extraction unit.

11. A method of extracting a skin area to block a harmful content image, comprising:
extracting, by an image extraction unit, an image from image media;
extracting, by a skin sample area extraction unit, a skin sample area of the image based on the image and previously stored prior information;
extracting, by a background sample area extraction unit, a background sample area of the image based on the image and the prior information;
calculating, by a probability density function computation unit, a probability density function of the skin sample area and a probability density function of the background sample area; and
extracting, by a skin area extraction unit, a skin area from the image based on the probability density functions of the skin sample area and the background sample area.

12. The method of claim 11, wherein extracting the skin area comprises:
generating, by the skin sample area extraction unit, a gray image-type alpha image for the image based on the prior information;
correcting, by the skin sample area extraction unit, pixels included in a false negative area of the alpha image;
correcting, by the skin sample area extraction unit, pixels included in a skin area of the alpha image; and
generating, by the skin sample area extraction unit, a binary skin sample area alpha map based on the alpha image in which the pixels included in the false negative area and the skin area have been corrected.

13. The method of claim 12, wherein generating the alpha image comprises, by the skin sample area extraction unit, generating the alpha image by calculating alpha values based on a color vector value at each coordinates, and a skin area probability density function value and a background area probability density function value for each color or based on a color vector value at each coordinates, a standard deviation of pixels of each color and an average value of pixels of each color and then assigning the alpha values to respective pixels included in the image.

14. The method of claim 12, wherein correcting the pixels in the false negative area comprises, on an assumption that an area which is isolated within an area of the alpha image classified as a skin area, an area whose three sides are adjacent to a skin area and whose brightness values are classified as a skin area, and an area which has similar brightness values and which is considered to be a background area are target pixels, increasing, by the skin sample area extraction unit, alpha values of pixels included in the corresponding areas.

15. The method of claim 12, wherein correcting the pixels included in the skin area comprises increasing, by the skin sample area extraction unit, alpha values by performing a conditional morphology closing operation and a conditional morphology dilation operation on pixels of the alpha image which are included in a skin area and in which a difference between their pixel value and a maximum value or minimum value within a window falls within a specific range.

16. The method of claim 11, wherein extracting the background sample area comprises:
generating, by the background sample area extraction unit, an edge-based background alpha map based on a background area extracted from the image;
generating, by the background sample area extraction unit, a peripheral background area alpha map based on the image; and
generating, by the background sample area extraction unit, a background sample area alpha map by summing the edge-based background alpha map and the peripheral background area alpha map.

17. The method of claim 16, wherein generating the edge-based background alpha map comprises:
calculating, by the background sample area extraction unit, edge components at respective pixels of the image using an edge operator;
generating, by the background sample area extraction unit, a binary edge map by mapping an edge value to each of the pixels based on the edge components and a threshold value;
segmenting, by the background sample area extraction unit, the image into a plurality of blocks, and summing, by the background sample area extraction unit, the edge values of pixels included in each of the blocks;
determining, by the background sample area extraction unit, whether each of the blocks is a background area block or a skin area block by comparing the sum of the edge values and a set value; and
generating, by the background sample area extraction unit, an edge-based background alpha map by assigning alpha values to the background area and skin area blocks.

18. The method of claim 16, wherein generating the peripheral background area alpha map comprises:
segmenting, by the background sample area extraction unit, the image into a plurality of peripheral blocks;
calculating, by the background sample area extraction unit, color distribution histograms of the peripheral blocks;
calculating, by the background sample area extraction unit, color distribution errors with respect to other peripheral blocks for each of the plurality of peripheral blocks;
calculating, by the background sample area extraction unit, reference functions of the plurality of peripheral blocks;
extracting, by the background sample area extraction unit, peripheral blocks for which a number and reference function of peripheral blocks whose color distribution errors are equal to or smaller than a set value are equal to or larger than a set value, as peripheral blocks belonging to a background area; and
generating, by the background sample area extraction unit, a peripheral background area alpha map by assigning alpha values to pixels of the peripheral blocks extracted as peripheral blocks belonging to a background area and other pixels.

19. The method of claim 11, wherein calculating the probability density functions comprises:
generating, by the probability density function computation unit, a foreground skin sample area alpha map in which an overlap area between the skin sample area alpha map and the background sample area alpha map has been excluded from the background sample area alpha map; and
calculating, by the probability density function computation unit, a histogram of the generated foreground skin sample area alpha map and a histogram of the background sample area alpha map.

20. The method of claim 11, wherein extracting the skin area from the image comprises:
generating, by the skin area extraction unit, an MLE skin alpha map of the image based on the histogram of the foreground skin sample area alpha map and the histogram of the background sample area alpha map; and
generating, by the skin area extraction unit, a final skin area alpha map by eliminating noise components from an alpha map that is generated by multiplying the MLE skin alpha map by the skin sample area alpha map.
